(19) United States
(12) Patent Application Publication
(10) Pub. No.: US 2024/0115081 A1
(43) Pub. Date: Apr. 11, 2024

(54) AUTOMATED SOUS VIDE RETHERMALIZATION AND FINISHING SYSTEM

(71) Applicant: Robert Almblad, Lynchburg, VA (US)

(72) Inventor: Robert Almblad, Lynchburg, VA (US)

(21) Appl. No.: 18/222,432

(22) Filed: Jul. 15, 2023

Related U.S. Application Data
(60) Provisional application No. 63/389,439, filed on Jul. 15, 2022.
(60) Provisional application No. 63/453,577, filed on Mar. 21, 2023.
(60) Provisional application No. 63/459,671, filed on Apr. 16, 2023.

(51) Int. Cl. A47J 44/00; A47J 36/24; B65B 69/00; H05B 3/00

(52) U.S. Cl. CPC A47J 44/00; A47J 36/2483; B65B 69/00; H05B 3/0076; A47J 27/18

(57) ABSTRACT

An automated sous vide rethermalization and finishing system includes a refrigerated compartment configured to store laminated sous vide food product; a sous vide food product rethermalization channel, operatively connected to the refrigerated compartment, configured to guide conveyance of laminated sous vide food product from said refrigerated compartment; a delamination system, operatively connected to the refrigerated compartment and the sous vide food product rethermalization channel, configured to delaminate laminated sous vide food product; and a sous vide food product finishing system, operatively connected to the sous vide food product rethermalization channel, configured to create a Maillard reaction upon a delaminated sous vide food product.

### PRIORITY INFORMATION

The present application claims priority, under 35 U.S.C. § 119(e), from U.S. Provisional Patent Application No. 63/389,439, filed on Jul. 15, 2022. The entire content of U.S. Provisional Patent Application No. 63/389,439, filed on Jul. 15, 2022, is hereby incorporated by reference.

The present application claims priority, under 35 U.S.C. § 119(e), from U.S. Provisional Patent Application No. 63/453,577, filed on Mar. 21, 2023. The entire content of U.S. Provisional Patent Application No. 63/453,577, filed on Mar. 21, 2023, is hereby incorporated by reference.

The present application claims priority, under 35 U.S.C. § 119(e), from U.S. Provisional Patent Application No. 63/459,671, filed on Apr. 16, 2023. The entire content of U.S. Provisional Patent Application No. 63/459,671, filed on Apr. 16, 2023, is hereby incorporated by reference.

### BACKGROUND

Various types of cooking devices are known in the art. Specifically, various types of grills are known. In one type of grill, the food is placed on a grilling surface, grilling the side of the food that contacts the grilling surface. After that side of the food is cooked, the food is manually turned or flipped to cook the opposite side. After the second side of the food is cooked, the food is removed from the grill for further preparation and/or serving.

In another type of grill, two-sided cooking is accomplished simultaneously. Such grills are commonly known as clamshell grills and have upper and lower cooking platens that are horizontally opposed for contacting the two sides of a food item simultaneously to thereby cook both sides simultaneously.

For proper performance, the two grilling surfaces should be parallel to each other so that each surface uniformly contacts and cooks the associated side of the food item that contacts a respective platen cooking surface.

There is a large amount of activity in the general field of restaurant automation in context of hygienic handling of various food product(s), and several studies and researches as well as invention(s) have delved upon the subject(s) of ‘packaging’ and ‘unpackaging’ procedures/methods. Protocols such as lamination, sheet-layering, foil packaging and peeling off, dismantling and delamination, at the manufacture sites (food processing factories/units) and usage sites (restaurants, hotels and eating points) are known to be in existence in the prior art profile.

The prior art discloses patents on delamination of a laminate, use of conveyor belts to transport laminated food products from one place to other, as well as use of several methods for unpacking the laminated food products such as peeling of film, delamination of laminated food and also in some cases the deployment of stripper unit. However, the prior art profile does not eliminate the need of human interference such as the food product directly passed on to a cooking unit.

U.S. Pat. No. 5,141,584 discloses an apparatus and method for delaminating a composite sheet structure of the kind comprising a vertically frangible layer having a first surface adhesively bonded to a first sheet at a substantially uniform strength and an opposite surface abutting areas which are, respectively, adhesively bonded to a second sheet at strengths less or greater than the uniform strength and having a marginal portion or tab extending beyond the first sheet. The entire content of U.S. Pat. No. 5,141,584 is hereby incorporated by reference.

U.S. Pat. No. 6,244,019 discloses a system for packaging and unpackaging can lids. The entire content of U.S. Pat. No. 6,244,019 is hereby incorporated by reference.

U.S. Pat. No. 8,367,977 discloses a compact portable heating device adapted to heat multiple food products simultaneously is provided. The entire content of U.S. Pat. No. 8,367,977 is hereby incorporated by reference.

U.S. Pat. No. 8,822,886 discloses a compact portable heating device adapted to heat multiple food products simultaneously is provided. The entire content of U.S. Pat. No. 8,822,886 is hereby incorporated by reference.

U.S. Pat. No. 9,861,229 discloses a movable door that directs debris, such as oil, grease, and food particles, that falls from a plurality of cooking slots in a vertical cooking grill to an area separate from a food product delivery tray, providing a cooked food product with reduced calories that is potentially more visually appealing. The entire content of U.S. Pat. No. 9,861,229 is hereby incorporated by reference.

U.S. Pat. No. 9,867,501 discloses a food loading system provides the ability to stage a volume of food in a freezer or cooler that keeps food product safely stored until the product is ready to be transferred to a cooking unit. The entire content of U.S. Pat. No. 9,867,501 is hereby incorporated by reference.

In addition, the closing device closes the open package end by compressing the bag end in the unfolding condition and in that fastening means are applied retaining the closed condition, and the unpacking device causes relative movement of the packages and the can lids contained therein in such a manner that the can lids are pressed against the package end closed by means of the fastening means.

Sous vide or cooking under a vacuum is well known, particularly in fine restaurants for the past several decades. It is the process of cooking food vacuum sealed in plastic for a long time at low temperatures. After the food is cooked, the plastic is removed and the food is “finished” with extreme heat to give it that crispy outer surface and taste and “mouth feel” that humans have grown to expect from well prepared foods. While sous vide is universally accepted and recognized as the best way known to cook food, it has some serious drawbacks. First and foremost, it takes a long time to cook food. Even for a single serving, it takes at least 1 to 2 hours depending on the thickness of the food. If a customer in a restaurant orders food, the customer does not want to wait that long to get served.

Another drawback is that each type of food being cooked needs to be cooked at an exact temperature for that particular food. For example, medium rare and medium steaks are cooked at 135° F. and 140° F. respectively. And, asparagus and carrots are cooked at different temperatures and for different lengths of time as well.

The combinations to make everyone happy in a typical restaurant are endless and would require customers to sit for hours while hundreds of different ovens and different chefs slowly cooked their food.

Since the sous vide method is the safest and best-tasting food, there have been many attempts to alleviate these inherent problems

In fine dining, chefs prepare the food sous vide style in multiple ovens days or weeks ahead of time and refrigerate the food and then rethermalate when the customer orders the food. This is a reasonable solution, but the labor costs, associated therewith, are so high.

To address this problem of sous vide only being available in fine dining and very expensive restaurants, a practical solution has been to cook sous vide style food at a central plant, where time is not an issue because the wholesale customer is the restaurant itself that is getting refrigerated 40° F. deliveries once a week rather than a restaurant's retail customer that is waiting in the dining room for their hot lunch in the next 15 minutes.

This wholesale method has worked fairly well so that more and more restaurants can now buy previously sous vide food from a large, national sous vide “plant” and then rethermalize and finish the previous sous vide'd food within 15 minutes after the retail restaurant customer orders the food from the dining room of the restaurant.

While this solution works fairly well for restaurants that have customers waiting in a sit-down dining room for 15 minutes and are willing to pay a premium price for a sit-down restaurant. It does not work for fast-food locations because not only is 15 minutes too long for the customer to wait, but also; fast food restaurants' success depends on the low price of their food which is mostly determined by the amount of labor used to deliver the food.

Generally speaking, fast-food restaurants need to prepare food in 30 seconds or less in order to meet the demands of their busy customers and to do this without adding additional personnel so they can have the profit margins needed to maintain an “ongoing business” in the meaning of the accounting term. If the time needed to prepare a food is more than 30 seconds, it is either not sold by the fast food restaurant or it is delivered on a “cook and hold” basis. The hold times are different for different products.

If the food is not used within the limited allotted time, it should be thrown away. If this food waste goes too high, the fast-food restaurant will not meet the definition of an ongoing business and therefore fail. Consequently, fast-food restaurants try to limit these losses by cooking faster and/or holding longer, both of which tend to degrade the food.

The overall problem that all restaurants face today is the availability, training, and cost of labor. Regardless of what food is served, labor is very expensive because of the training needed to work with food. Mistakes can not only make the business fail because the food tastes bad or the service is bad, but also, if there is mishandling of food, it can cause the sickness or death of restaurant customers.

The obvious solution has been to automate the restaurant. While there have been many attempts to automate cooking with robots, none have been very successful. The main problem with automation has been the size and sanitation of equipment intended to work inside a modern restaurant kitchen.

The features of the afore-mentioned prior art disclose complex design and bulky structural indices thereby hindering utilization in restaurant automation devices.

Moreover, the afore-mentioned prior art fails to address the use of restaurant automation in highly aseptic conditions by eliminating human interference during transfer of food products from refrigerated storage to cooking unit.

Therefore, it is desirable to provide a system that enables the automation of a meat cooking apparatus which minimizes human interaction and provides an efficient and consistent cooking process.

### BRIEF DESCRIPTION OF THE DRAWING

The drawings are only for purposes of illustrating various embodiments and are not to be construed as limiting, wherein:

FIG. 1 is a perspective view of an exemplary embodiment of the heating device of a conventional vertical grill;

FIG. 2 is a front end view of the device of FIG. 1;

FIG. 3 is a top view of the device of FIG. 1 with the product door in the support position;

FIG. 4 is a top view of the device of FIG. 1 with the product door in the drop position;

FIG. 5 is a perspective view of the device of FIG. 1 with the housing removed;

FIG. 6 is a side view of the device of FIG. 5;

FIG. 7 is a block diagram illustrating a sous vide food product storage, rethermalization, and finishing system;

FIG. 8 is a block diagram illustrating a system for conveying and delaminating sous vide food products;

FIG. 9 illustrates a goose-necked shaped sous vide food product channel and rethermalization system; and

FIG. 10 illustrates a sous vide food product finishing system.

### DETAILED DESCRIPTION OF THE DRAWINGS

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

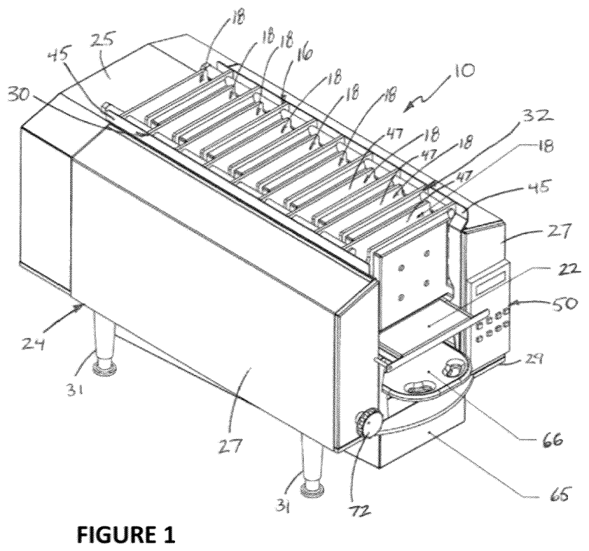

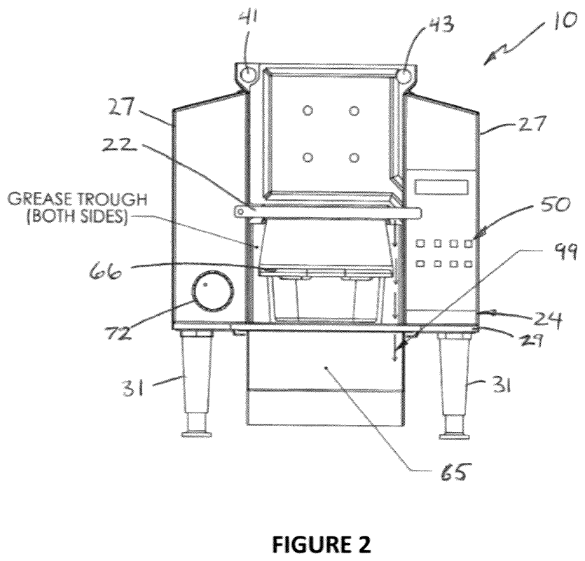

Referring to FIGS. 1-6, an exemplary embodiment of a conventional food product heating device 10 includes one or more heat generators 12 and 14, multiple heating elements 16 positioned adjacent one another to create at least one heating slot 18 for receiving a food product, a movable product door 22 for supporting and controlling the position of the food product, and a housing 24. The device 10 heats and/or cooks multiple food products, such hamburgers, chicken cutlets, fish patties, vegetable burgers, or any other food product capable of being positioned in slot 18 by simultaneously applying heat to both sides of each food product.

Heating device 10 is effective in heating and/or cooking raw food products, whether frozen or not, and food products that have been previously cooked and require reheating. Heating device 10 is a small, compact, and portable unit that uses vertical space thereby occupying a minimum amount of horizontal space, e.g. counter area, and maximizing the ratio of food product heated per square foot of horizontal space occupied by the device.

As shown in the FIG. 1 and FIGS. 3-5, multiple heating elements 16 include a first set or array of heating elements 30 and a second set or array of heating elements 32. First set and second set of heating elements 30 and 32, respectively, are be connected to a first and a second heat generator 12 and 14, respectively, at one lower corner of heating elements 30 and 32 to form a first heating assembly 33 and a second heating assembly 35, respectively. In this manner, each heat generator provides physical support to the respective set of heating elements

First heating assembly 33, comprising first set of heating elements 30 and first heat generator 12, is movably mounted for sliding movement along longitudinal axis 2 of device 10 on linear bearings 34 mounted inside housing 24. It is noted that the first set of heating elements 30 do not move independent of each other, but are tied together to move together.

The second heating assembly 35, comprising second set of heating elements 32 and second heat generator 14, is stationary and fixedly mounted to housing 24. Housing 24 may include a rear section 25, side sections 27, a lower base 29, legs 31, and grease walls 45.

First set of heating elements 30 are meshed with second set of heating elements 32 so as to overlap and alternate along the longitudinal axis 2 of the device to form pairs of heating elements where each pair forms a heating slot 18 and includes one heating element from first set of heating elements 30 and one heating element from second set of heating elements 32.

Once uncooked food product is loaded or inserted into slots 18, first heat assembly 33 is moved or shifted linearly and axially along the longitudinal axis 2 causing all the first set of heating elements 30 to move closer to second set of heating elements 32 to contact the food product and enable heating.

Each heating element 16 of the first and second set of heating elements 30, and 32 include a platen or plate 36 and a back portion 38 connected to or formed on plate 36 to create an inner chamber 40. The chamber 40 is capable of withstanding a maximum internal pressure of, for example, 250 psi.

Each plate 36 includes a generally flat or planar heating surface 47 so that the opposing flat heating surfaces of adjacent plates 36 are positioned adjacent and generally parallel to one another to partially form slots 18.

The plates 36 are spaced in the loading position to form slots 18 of a sufficient size (width) to receive a food product of a particular size between heating elements 16 for heating on both sides of the food product simultaneously by direct contact with opposite plates 36. Back portions 38 are connected to respective plates 36 by welding. Each plate 36 and back portion 38 include an extension section 39 with a connection chamber 49 positioned at one corner and extending to fluidly connect with respective heat generators 12 and 14. The extension section 39 extends through, and is connected to, the respective grease wall 45. The grease wall 45, on the side of the device having the first heating assembly 33, moves with the first heating assembly.

Each heating element 16 is positioned so that the opposing heating surfaces 47 extend transverse to the horizontal support surface supporting the device. Heating surfaces 47 are positioned substantially vertical so that slots 18 are also positioned substantially vertical, and in series along the longitudinal axis 2 of device 10.

As a result, slots 18, and heating surfaces 47, are positioned substantially perpendicular to the longitudinal axis 2 of device 10, and any generally flat surface on which the device 10 is supported.

The width of slots 18 can be adjusted to accommodate different sized food product using an adjustment mechanism 70 to permit selective adjustment of the extent of the linear movement of first heating assembly 33. An adjustment stop mechanism 70 includes a knob 72, a rotatable shaft 74 connected to the knob at one end, and a stop wheel 76 connected to an opposite end of shaft 74. Stop wheel 76 includes a plurality of stops or protrusions 78 extending axially from, and positioned annularly around, one side of stop wheel 76 for contact by a bracket 80 fixedly attached to movable first heating assembly 33.

Each of protrusions 78 extend from stop wheel 76 a different distance to create a different axial ending position of the first heating assembly 33 in the heating position. A user rotates knob 72 to a position to create a particular stop position corresponding to a desired heating slot width.

A bias spring 82 is mounted between a portion of housing 24 and bracket 80 to bias bracket 80 and thus first heating assembly 33 toward the heating position as limited by an aligned protrusion 78. Adjustment stop mechanism 70 may be a manual or automated device including mechanical and/or electronic device capable of providing a limit to the axial position of the assembly 33.

First and second support manifolds 41 and 43 extend along the top of a respective set of plates 36 associated with first and second heating elements 30 and 32, respectively. Manifolds 41 and 43 are hollow tubes that connect the chambers 40 of the respective set of heating elements associated with the respective heating assemblies 33 and 35.

The steam from one chamber is fluidly connected to the respective manifold via a branch passage and thus connected to all other chambers of the heating elements in the respective first or second set of heating elements. Since the manifolds are positioned at or near a high point in the system, each manifold includes a removable end cap that can be used to bleed air from the system and to add condensate to the system.

All chambers of first set of heating elements are commonly connected to both heat generator and manifold and also interconnected to one another via manifold via branch passages, while all chambers of second set of heating elements are commonly connected to heat generator and manifold and also interconnected via manifold and respective branch passages.

Each heat generator and may be a steam generator capable of containing a condensate/liquid, such as water, and generating steam. Each heat generator may include condensate housing or manifold and a heater, such as an electric heater, positioned inside condensate housing for heating the condensate.

Steam generated in each housing flows upwardly into the various respective chambers of the respective set of heating elements, thereby providing heat to plates. The steam provides heat to plates and the food product, causing the steam to condense to a liquid which then drains back to housing.

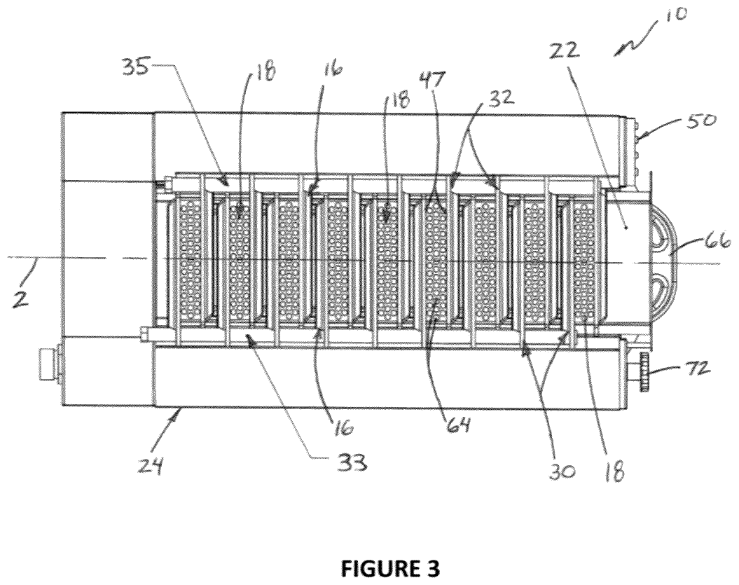

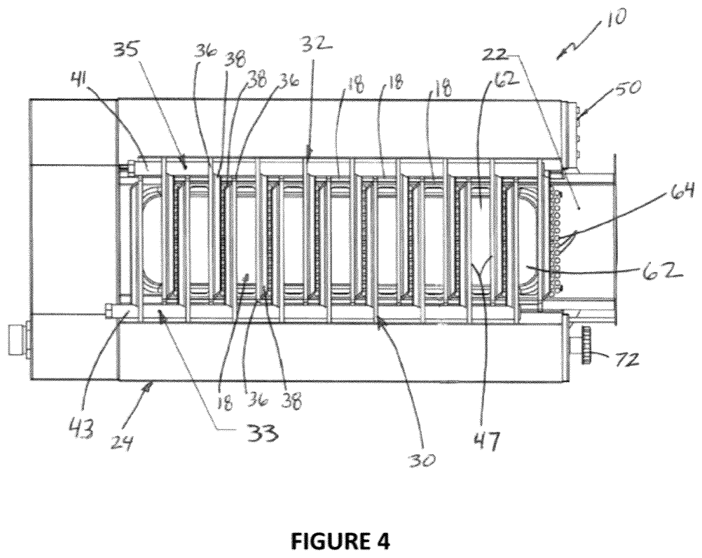

Heating device includes a product door slidably mounted on housing below first and second heating elements for shifting/sliding movement between a support position shown in FIG. 3 and a drop position shown in FIG. 4.

As shown in FIG. 3, in the support position, with product door 22 pushed inwardly, drain holes 64 are aligned with slots 18 to allow product door 22 to support a food product during insertion and heating of the food product while permitting fluids, such as grease, to flow out of slots 18 to grease pan 65. In the support position, exit openings 62 are positioned out of alignment with slots 18 and directly under a heating element.

As shown in FIG. 4, in the drop position, with product door 22 pulled outwardly, drain holes 64 are moved out of alignment with respective slots 18 and exit openings 62 are each positioned in alignment with slots 18 to cause the heated/cooked food product to fall by gravity onto a receiving tray 66 for removal by sliding tray 66 outwardly.

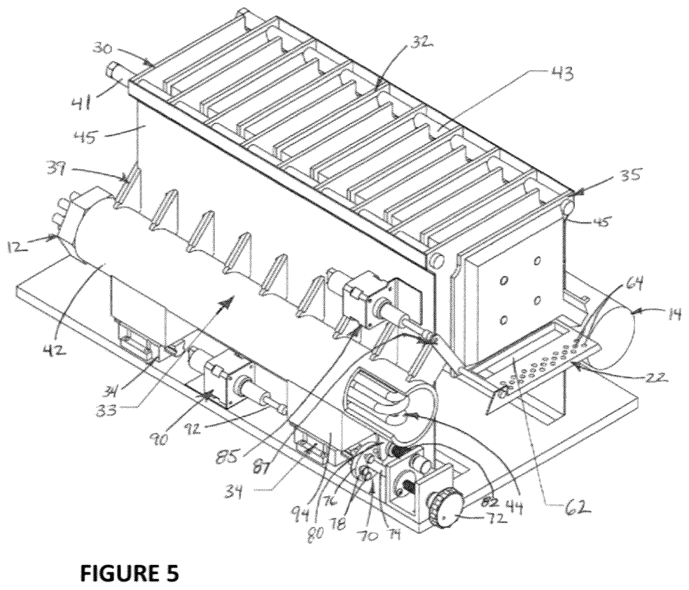

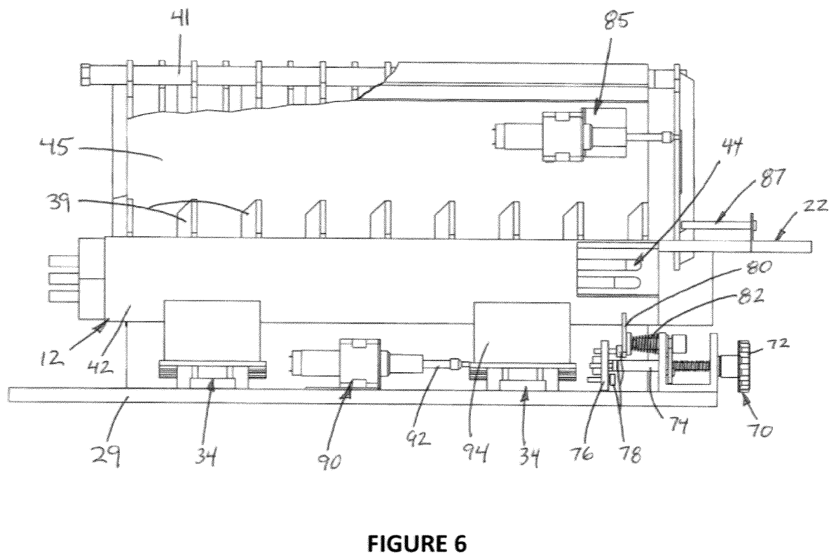

Referring to FIGS. 5 and 6, first heating assembly 33 may be mounted and arranged to be moved manually along linear bearings 34 by a user or, preferably, automatically moved by operation of a linear actuator 90, such as an electric motor and drive assembly, such as a screw type drive, or a solenoid actuator. Spring 82 is compressed when first heating assembly 33 is moved by an automatic actuator, i.e. linear actuator 34, away from the heating elements of the other heating assembly 35 into a loading position. A shaft 92 of linear actuator 34 abuts a lower portion of a generator support 94. Then, upon deactivation of linear actuator 34, and reverse movement of the shaft 92 of linear actuator 34, first heating assembly 33 is moved back into the heating position against the food product by spring 82.

Electronic controls 50 may be provided for on/off control of heaters 44 together or independently, automatic operation of the linear actuator 90 to control axial movement of heating assembly 33, and automatic operation of product door 22. All functions needed to complete a heating cycle are preprogrammed in the electronic controls 50 and initiated by activation of a single button by a user.

During operation, the unit is turned on to cause the heater to begin heating the condensate. An indicator, such as a light, may be provided to indicate when the unit has reached a predetermined temperature and is ready for heating operation. A user may initiate the unit by activating a load button to cause the automatic controls to move the first heating assembly into the loading position and the product door to move into the support position.

Food product is then placed in slots and the cycle can continue by, for example, the user actuating another switch to initiate a heating cycle, such as selecting a preset heating or cook time. The cycle may include the linear/axial shifting or sliding movement of first heating assembly toward second set of heating elements to contact the food product, preferably on both sides.

After a desired period of time determined by the user manually or by the preset automatic control, product door is automatically moved into the drop position and then the first heating assembly is moved linearly/axially away from second set of heating elements and away from the food product allowing the food to drop by gravity onto receiving tray for removal by a user.

An example of a vertical cooking grill is disclosed in U.S. Pat. No. 8,397,977. The entire content of U.S. Pat. No. 8,397,977 is hereby incorporated by reference.

Another example of a vertical cooking grill is disclosed in U.S. Pat. No. 8,822,886. The entire content of U.S. Pat. No. 8,822,886 is hereby incorporated by reference.

An example of a movable door for a vertical cooking grill is disclosed in U.S. Pat. No. 9,861,229. The entire content of U.S. Pat. No. 9,861,229 is hereby incorporated by reference.

In a sous vide food system, a food product is cooked sous vide style at a plant. Thereafter, the cooked sous vide food product is shipped to a restaurant under refrigeration to be heated and “finished” with intense heat to create the Maillard reaction. However, if the food is taken out of refrigeration and immediately subjected to intense heat long enough to increase the internal temperature, so it is not cold inside, the food item, the soft moist sous vide center will be lost due to “over cooking.”

In other words, if the food is taken out of refrigeration and fried in a hot pan or otherwise cooked with heat source long enough to get the internal refrigerated temperature up to above refrigerated temperatures, it will be overcooked.

If the food is gently and slowly warmed before or after the intense heat treatment, it will take too long to be served as a “cook to order” in a fast-food restaurant, which requires food to be made in only 30 seconds or otherwise it is not accepted in a fast food restaurant or alternatively it is a “cook and hold” product.

Moreover, when food is held in a heated holding cabinet, the quality of the food deteriorates, obfuscating the reason for making high quality food like sous vide in the first place.

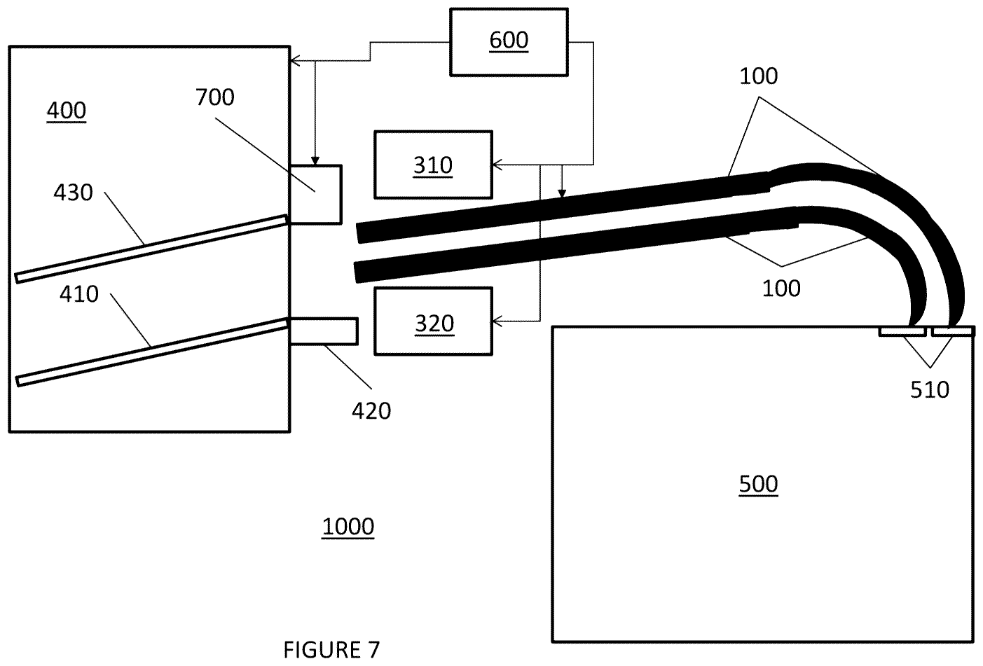

FIG. 7 illustrates a block diagram of an automated sous vide rethermalization and finishing system 1000. The automated sous vide rethermalization and finishing system 1000 includes a refrigerated compartment 500 for storing laminated sous vide food product (not shown). The refrigerated compartment 500 is operatively connected to connected a heated gooseneck shaped sous vide food product rethermalization channel 100 to gently reheat laminated sous vide food product (not shown).

The automated sous vide rethermalization and finishing system 1000 includes a sous vide food product finishing system 400 for finishing the cooking of a delaminated sous vide product with intense heat to create the Maillard reaction. Also, the automated sous vide rethermalization and finishing system 1000 includes a delamination system that includes delaminators 310 and 320.

As illustrated in FIG. 7, a controller 600 controls the operations of the heated gooseneck shaped sous vide food product rethermalization channel 100, delaminators 310 and 320, and the sous vide food product finishing system 400.

The automated sous vide rethermalization and finishing system 1000 includes a camera or imaging system 700, which is operatively connected to the controller 600 and monitors the status of the lamination films at an exit end of the heated gooseneck shaped sous vide food product rethermalization channel 100. If the camera or imaging system 700 captures image data that the controller 600 determines that one of the laminate films is showing excess slack at the exit end of the heated gooseneck shaped sous vide food product rethermalization channel 100, the controller 600 controls the delaminators 310 and 320, respectively, to take up the excess slack at the exit end of the heated gooseneck shaped sous vide food product rethermalization channel 100.

A brief description of the operations of the automated sous vide rethermalization and finishing system 1000 will be provided. The laminated sous vide food product (not shown) is stored inside the refrigerated compartment 500. The laminated sous vide food product (not shown) is laminated between two strips of film (not shown) so that the sous vide food product (not shown) is sealed therebetween.

The refrigerated compartment 500 includes, as illustrated in FIG. 7, a set of insulated doors 510, which can swing open as a laminated sous vide food product (not shown) passes therethrough and swings close after the laminated sous vide food product (not shown) has passed therethrough.

The laminated sous vide food product (not shown) is brought up or pulled, via the delaminators 310 and 320 pulling the laminate films (not shown), through the heated gooseneck shaped sous vide food product rethermalization channel 100. The heated gooseneck shaped sous vide food product rethermalization channel 100 gently reheats the laminated sous vide food product (not shown) to an internal temp of about 90° F. to 110° F. while traveling through the heated gooseneck shaped sous vide food product rethermalization channel 100.

As the laminated sous vide food product (not shown) leaves the heated gooseneck shaped sous vide food product rethermalization channel 100 at the exit end, the laminated sous vide food product (not shown) is delaminated from the laminated film (not shown), using the delaminators 310 and 320. The delaminated sous vide food product (not shown) is then dispensed into a high heat source or the sous vide food product finishing system 400 to finish the sous vide food product.

The sous vide food product finishing system 400 includes a waste tray 420 for capturing any waste associated with the sous vide food product from the delamination process. The sous vide food product finishing system 400 also includes conveyor 410 and an infrared heat source 430, which finishes the cooking of the sous vide product with intense heat to create the Maillard reaction. The infrared heat source 430 may be located above the conveyor 410, below the conveyor 410, or above and below the conveyor 410.

As illustrated in FIG. 7, the automated sous vide rethermalization and finishing system 1000 is both a sous vide dispenser and a heater/rethermalizer that can deposit a sous vide food product onto a high heat source, like an infrared heat source, to finish cooking the sous vide food product in high heat and be ready to give to a customer.

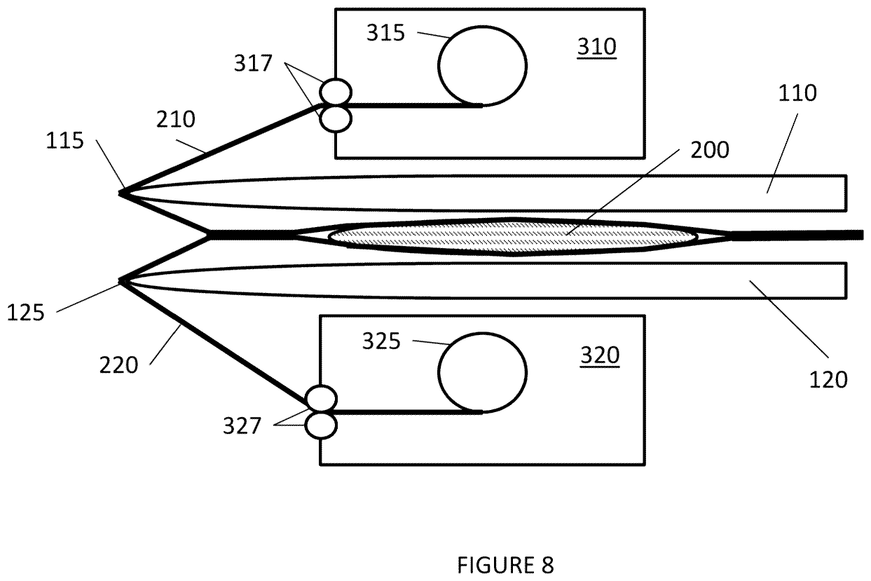

FIG. 8 illustrates the delamination system for the automated sous vide rethermalization and finishing system of FIG. 7. As illustrated in FIG. 8, the delamination system includes a first delaminator 310 and a second delaminator 320.

The first delaminator 310 includes a first film take-up reel 315 and rollers 317 to guide a first film 210 into the first delaminator 310. The first film take-up reel 315 is motorized so that the first delaminator 310 can pull the first film 210 through a heated gooseneck shaped sous vide food product rethermalization channel, constructed of first guide 110 and second guide 120.

The first film 210 travels through the heated gooseneck shaped sous vide food product rethermalization channel, near the first guide 110. As the first film 210 leaves the heated gooseneck shaped sous vide food product rethermalization channel, the first film 210 travels around nip 115 to assist in the separation of the first film 110 from second film 220. The nip 115 is a configured curve at an exit end of the first guide 110.

The second delaminator 320 includes a second film take-up reel 325 and rollers 327 to guide the first film 220 into the second delaminator 320. The second film take-up reel 325 is motorized so that the second delaminator 320 can pull the second film 220 through a heated gooseneck shaped sous vide food product rethermalization channel, constructed of first guide 110 and second guide 120.

The second film 220 travels through the heated gooseneck shaped sous vide food product rethermalization channel, near the second guide 120. As the second film 220 leaves the heated gooseneck shaped sous vide food product rethermalization channel, the second film 220 travels around nip 125 to assist in the separation of the first film 110 from the second film 220. The nip 125 is a configured curve at an exit end of the second guide 120.

The delamination system for the automated sous vide rethermalization and finishing system delaminates the first film 110 from the second film 220 to unseal the sous vide food product 200 from the first film 110 and the second film 220. The movement of the first film 110 and the second film 220 during the delamination process provides momentum to propel the sous vide food product 200 onto the conveyor in the sous vide food product finishing system.

The delaminator system of FIG. 8 is similar, in concept and operations, to the delaminators disclosed in U.S. Pat. No. 11,383,506. The entire content of U.S. Pat. No. 11,383,506 is hereby incorporated by reference.

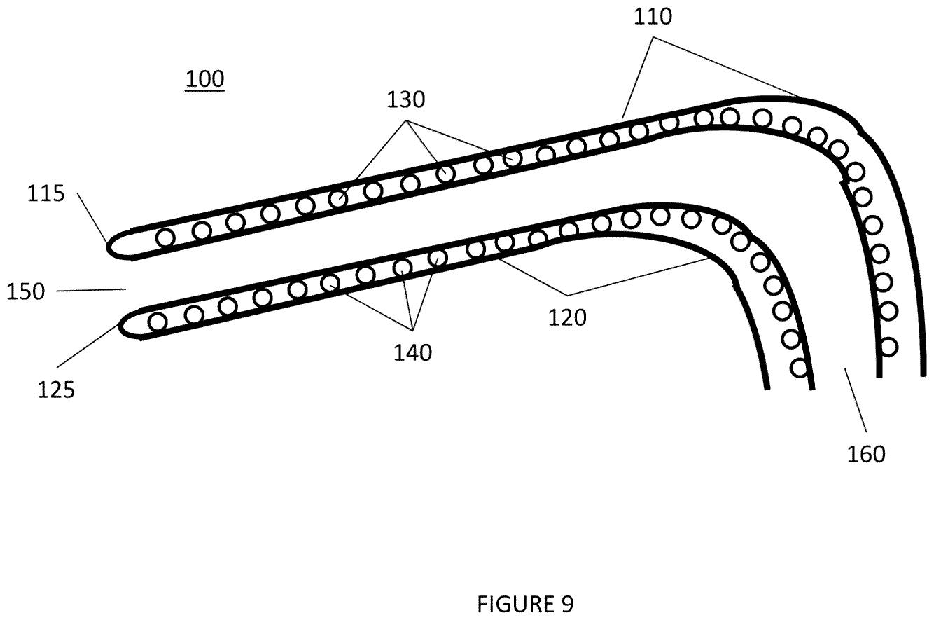

FIG. 9 illustrates a heated gooseneck shaped sous vide food product rethermalization channel. The heated gooseneck shaped sous vide food product rethermalization channel 100 is constructed of a first guide 110 and a second guide 120. The first guide 110 and a second guide 120, each, have an entrance end 160 and an exits end 150. The exit end 150 of the first guide 110 is configured to form a nip 115 for assisting in a delamination process. The exit end 150 of the second guide 120 is configured to form a nip 125 for assisting in a delamination process.

The first guide 110 includes a plurality of thermal elements 130 to provide heat. The thermal elements 130 provide regulated heat to the gooseneck shaped sous vide food product rethermalization channel 100 to gently heat a sous vide food product located therein.

The second guide 120 includes a plurality of thermal elements 140 to provide heat. The thermal elements 140 provide regulated heat to the gooseneck shaped sous vide food product rethermalization channel 100 to gently heat a sous vide food product located therein.

Although FIG. 9 illustrates that both guides include thermal elements, the thermal elements may be included in only one guide.

The plurality of thermal elements 130 may be independently be controlled to control the heat at any particular location along the gooseneck shaped sous vide food product rethermalization channel 100. The plurality of thermal elements 130 may be grouped into zones, wherein each zone may be independently be controlled to control the heat at the particular zone along the gooseneck shaped sous vide food product rethermalization channel 100.

The plurality of thermal elements 140 may be independently be controlled to control the heat at any particular location along the gooseneck shaped sous vide food product rethermalization channel 100. The plurality of thermal elements 140 may be grouped into zones, wherein each zone may be independently be controlled to control the heat at the particular zone along the gooseneck shaped sous vide food product rethermalization channel 100.

For example, the plurality of thermal elements 130 or the plurality of thermal elements 140, located at the entrance end 160 of the gooseneck shaped sous vide food product rethermalization channel 100 may be controlled, by a controller (not shown), to heat the zone at the entrance end 160 of the gooseneck shaped sous vide food product rethermalization channel 100 to a temperature of 85° F., whereas the plurality of thermal elements 130 or the plurality of thermal elements 140, located at the exit end 150 of the gooseneck shaped sous vide food product rethermalization channel 100 may be controlled, by a controller (not shown), to heat the zone at the exit end 150 of the gooseneck shaped sous vide food product rethermalization channel 100 to a temperature of 130° F.

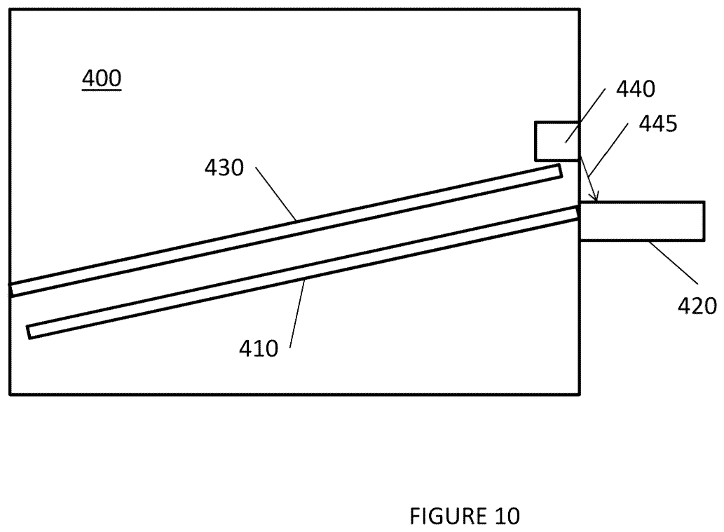

FIG. 10 illustrates a sous vide food product finishing system. As illustrated in FIG. 10, the sous vide food product finishing system 400 includes a waste tray 420 for capturing any waste associated with the sous vide food product from the delamination process.

The sous vide food product finishing system 400 also includes a conveyor 410, which conveys the sous vide food product through the sous vide food product finishing system 400 to finish the cooking of the sous vide product with intense heat to create the Maillard reaction.

The sous vide food product finishing system 400 further includes an air drying pre-treatment system 430 that blows air 445 over the sous vide product (not shown) to dry the sous vide product and remove the excess moisture from the sous vide product. The excess moisture from the sous vide product is collected in the waste tray 420 using a vacuum.

The waste tray 420 is located below the conveyor 410 of the sous vide food product finishing system 400. The sous vide food product finishing system 400 may be ventless. The conveyor 410 may not be solid to allow the excess moisture and air to pass therethrough, but solid enough to hold the sous vide product.

The sous vide food product finishing system 400 also includes an infrared heat source 430 to finish the cooking of the sous vide product with intense heat to create the Maillard reaction.

Additionally, since there are multiple food items traveling in the gooseneck, there is time for the food items to heat up because each food item is taken out one at a time, giving the remaining food items in the gooseneck time for the internal temperature to slowly come up to a proper temperature.

As discussed above, an automated sous vide rethermalization and finishing system includes a refrigerated compartment for storing sous vide products, such as sous vide protein. The sous vide products are sealed and laminated with a film. The sous vide product is transported through a gooseneck shaped sous vide food product rethermalization channel that slowly and gently raises the temperature of the sous vide product, before it is discharged onto a sous vide food product finishing system that finishes the cooking of the sous vide product with intense heat to create the Maillard reaction.

Moreover, the automated sous vide rethermalization and finishing system includes pinch rollers to pull the laminate (film) through the gooseneck shaped sous vide food product rethermalization channel, which slowly and gently raises the temperature of the sous vide product. The film exits the gooseneck shaped sous vide food product rethermalization channel and around a nip before being engaged by the pinch rollers.

The automated sous vide rethermalization and finishing system, in response to the pinch rollers pulling the laminate (film) through the gooseneck shaped sous vide food product rethermalization channel, discharges the sous vide product into the sous vide food product finishing system. As noted above, the nip of the gooseneck shaped sous vide food product rethermalization channel enables the laminated film to delaminate and unseal the sous vide product.

As the film leaves the pinch rollers, it is stored on a waste wheel.

When the waste wheel reaches capacity for storing the delaminated film, the film can be cut and the roll of waste laminate (film) can be removed.

When the delaminated film can be engaged with the waste laminate (film) roller to begin a new roll of waste laminate (film).

The sous vide products are stored in a refrigerated compartment; e.g., stored at 40° F. The sous vide products can be also stored in the gooseneck shaped sous vide food product rethermalization channel; e.g., stored at 40° F.; when the sous vide machine is not in use.

As the automated sous vide rethermalization and finishing system is being started up, the gooseneck shaped sous vide food product rethermalization channel begins, warm-up mode, slowly and gently raising the temperature of the sous vide products in the gooseneck shaped sous vide food product rethermalization channel.

As the automated sous vide rethermalization and finishing system is being shut down, the gooseneck shaped sous vide food product rethermalization channel begins, cooldown mode, slowly and gently lowering the temperature of the sous vide products in the gooseneck shaped sous vide food product rethermalization channel.

The temperature of the sous vide products are slowly and gently raised as the sous vide products travel through the gooseneck shaped sous vide food product rethermalization channel.

The automated sous vide rethermalization and finishing system includes a sous vide food product finishing system to finish cooking of the sous vide product with intense heat to create the Maillard reaction. As the sous vide product is discharged from the gooseneck shaped sous vide food product rethermalization channel, the sous vide product passes by an air drying pre-treatment section that blows air over the sous vide product to dry the sous vide product and remove the excess moisture from the sous vide product. The excess moisture from the sous vide product is collected in a waste chamber using a vacuum. The waste chamber is located below the conveyor belt of the sous vide food product finishing system. The conveyor belt may not be solid to allow the excess moisture and air to pass therethrough, but solid enough to hold the sous vide product.

The refrigerated compartment can be easily restocked, by opening the compartment.

A new package of laminated sealed sous vide products are loaded into the refrigerated compartment. Thereafter, the end of the laminate (film) of the previous package of laminated sealed sous vide products is attached to the beginning of the laminate (film) of the new package of laminated sealed sous vide products to create a continuous package of laminated sealed sous vide products. The refrigerated compartment is closed up and the operations of the sous vide machine can resume.

The automated sous vide rethermalization and finishing system uses a “wind up” process to collect the waste plastic material. Moreover, when the sous vide product is delaminated, there is a watery liquid from the cooking process that is drained using a blower and a vacuum to remove as much liquid as possible just before sending the sous vide product to the sous vide food product finishing system.

The sous vide product is dried as much as possible to reduce smoke and water vapor in the “sous vide food product finishing system” and to create a “crispy” surface. The sous vide product needs to be a dry surface to create that crispy effect.

An automated sous vide rethermalization and finishing system, comprises a refrigerated compartment configured to store laminated sous vide food product; a sous vide food product rethermalization channel, operatively connected to the refrigerated compartment, configured to guide conveyance of laminated sous vide food product from the refrigerated compartment; a delamination system, operatively connected to the refrigerated compartment and the sous vide food product rethermalization channel, configured to delaminate laminated sous vide food product; and a sous vide food product finishing system, operatively connected to the sous vide food product rethermalization channel, configured to create a Maillard reaction upon a delaminated sous vide food product.

The sous vide food product rethermalization channel may be gooseneck shaped.

The sous vide food product rethermalization channel may include a plurality of thermal elements configured to rethermalize laminated sous vide food product.

The plurality of thermal elements may be configured to be independently controlled.

The plurality of thermal elements may be configured into a plurality of zones, the zones being independently controlled.

The sous vide food product finishing system may include an infrared heat source configured to create the Maillard reaction upon the delaminated sous vide food product and a conveyor.

The sous vide food product finishing system may include an air drying pre-treatment system configured to blow air over delaminated sous vide food product.

A sous vide food product rethermalization channel, comprises a first guide; a second guide; the first guide and the second guide being configured to form a channel for conveying a laminated sous vide food product; the first guide including a plurality of first guide thermal elements configured to rethermalize the conveying laminated sous vide food product.

The second guide may include a plurality of second guide thermal elements configured to rethermalize the conveying laminated sous vide food product.

The plurality of first guide thermal elements may be configured to be independently controlled.

The plurality of first guide thermal elements may be configured into a plurality of zones, the zones being independently controlled.

The plurality of second guide thermal elements may be configured to be independently controlled.

The plurality of second guide thermal elements may be configured into a plurality of zones, the zones being independently controlled.

The first guide may be gooseneck shaped and the second guide may be gooseneck shaped.

The first guide may include a first guide entrance end and a first guide exit end; the first guide exit end being configured as a nip.

The second guide may include a second guide entrance end and a second guide exit end; the second guide exit end being configured as a nip.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

What is claimed is:

1. An automated sous vide rethermalization and finishing system, comprising:
a refrigerated compartment configured to store laminated sous vide food product;
a sous vide food product rethermalization channel, operatively connected to said refrigerated compartment, configured to guide conveyance of laminated sous vide food product from said refrigerated compartment;
a delamination system, operatively connected to said refrigerated compartment and said sous vide food product rethermalization channel, configured to delaminate laminated sous vide food product; and
a sous vide food product finishing system, operatively connected to said sous vide food product rethermalization channel, configured to create a Maillard reaction upon a delaminated sous vide food product.

2. The automated sous vide rethermalization and finishing system, as claimed in claim 1, wherein said sous vide food product rethermalization channel is gooseneck shaped.

3. The automated sous vide rethermalization and finishing system, as claimed in claim 1, wherein said sous vide food product rethermalization channel includes a plurality of thermal elements configured to rethermalize laminated sous vide food product.

4. The automated sous vide rethermalization and finishing system, as claimed in claim 3, wherein said plurality of thermal elements are configured to be independently controlled.

5. The automated sous vide rethermalization and finishing system, as claimed in claim 3, wherein said plurality of thermal elements are configured into a plurality of zones, said zones being independently controlled.

6. The automated sous vide rethermalization and finishing system, as claimed in claim 1, wherein said sous vide food product finishing system includes an infrared heat source configured to create the Maillard reaction upon the delaminated sous vide food product and a conveyor.

7. The automated sous vide rethermalization and finishing system, as claimed in claim 1, wherein said sous vide food product finishing system includes an air drying pre-treatment system configured to blow air over delaminated sous vide food product.

8. A sous vide food product rethermalization channel, comprising:
a first guide;
a second guide;
said first guide and said second guide being configured to form a channel for conveying a laminated sous vide food product;
said first guide including a plurality of first guide thermal elements configured to rethermalize the conveying laminated sous vide food product.

9. The sous vide food product rethermalization channel, as claimed in claim 8, wherein said second guide including a plurality of second guide thermal elements configured to rethermalize the conveying laminated sous vide food product.

10. The sous vide food product rethermalization channel, as claimed in claim 8, wherein said plurality of first guide thermal elements are configured to be independently controlled.

11. The sous vide food product rethermalization channel, as claimed in claim 8, wherein said plurality of first guide thermal elements are configured into a plurality of zones, said zones being independently controlled.

12. The sous vide food product rethermalization channel, as claimed in claim 9, wherein said plurality of second guide thermal elements are configured to be independently controlled.

13. The sous vide food product rethermalization channel, as claimed in claim 9, wherein said plurality of second guide thermal elements are configured into a plurality of zones, said zones being independently controlled.

14. The sous vide food product rethermalization channel, as claimed in claim 8, wherein said first guide is gooseneck shaped and said second guide is gooseneck shaped.

15. The sous vide food product rethermalization channel, as claimed in claim 8, wherein said first guide includes a first guide entrance end and a first guide exit end;
said first guide exit end being configured as a nip.

16. The sous vide food product rethermalization channel, as claimed in claim 8, wherein said second guide includes a second guide entrance end and a second guide exit end;
said second guide exit end being configured as a nip.

17. The sous vide food product rethermalization channel, as claimed in claim 15, wherein said second guide includes a second guide entrance end and a second guide exit end;
said second guide exit end being configured as a nip.
